(19) United States
(12) Patent Application Publication
(10) Pub. No.: US 2015/0300592 A1
(43) Pub. Date: Oct. 22, 2015

(54) DECORATIVE LAMP

(71) Applicant: Juntao Liu, (US)

(72) Inventor: Juntao Liu, Shenzhen (CN)

(21) Appl. No.: 14/441,093

(22) PCT Filed: Oct. 18, 2013
(86) PCT No.: PCT/CN2013/085430

§ 371 Date: May 6, 2015

(30) Foreign Application Priority Data
Oct. 16, 2013 (CN) 201310486278.X

(51) Int. Cl. F21V 3/04; F21V 31/00

(52) U.S. Cl. CPC F21V 3/0409; F21V 31/005; F21W 2121/00

(57) ABSTRACT

A decorative lamp of the present disclosure includes a housing, a circuit board arranged in the housing, a bottle arranged at a top part of the housing and containing liquid, a bottle stopper sealing a bottle opening of the bottle, and a head cover sleeved around the bottle stopper. A lamp is arranged on the circuit board, which avoids damage of the bottle stopper and makes the bottle stopper closely match with the bottle opening, thereby avoiding leakage of liquid due to looseness of the bottle stopper.

### TECHNICAL FIELD

The present disclosure relates to the field of lamps, and more particularly to a decorative lamp.

### BACKGROUND

Applicant has designed a decorative lamp, where the decorative lamp is connected to a computer by a universal serial bus (USB) interface. The decorative lamp includes a housing, a circuit board arranged in the housing, and a bottle arranged at a top part of the housing, and containing liquid. A tricolor light is arranged on the circuit board, the circuit board is connected to the bottle, and light emitted by the tricolor light passes through the bottle and dissipates about. A bottle opening is arranged at a top part of the bottle, and the decorative lamp further includes a bottle stopper that seals the bottle opening. The above-mentioned decorative lamp is not disclosed. However, the bottle stopper is exposed, which makes the bottle stopper be easily damaged and removed, thus, causing leakage of liquid.

### SUMMARY

The aim of the present disclosure is to provide a decorative lamp capable of avoiding damage of a bottle stopper.

The aim of the present disclosure is achieved by the following methods: a decorative lamp of the present disclosure comprises a housing, a circuit board arranged in the housing, a bottle arranged at a top part of the housing a bottle stopper sealing a bottle opening of the bottle, and a head cover sleeved around the bottle stopper, where the bottle contains liquid, and a lamp is arranged on the circuit board.

Furthermore, the head cover is sleeved around the bottle stopper and is matched with the bottle, which makes the bottle stopper be completely arranged in the head cover, thus, damage of the bottle stopper is avoided, and the head cover is easily matched with the bottle.

Furthermore, the bottle is a circular truncated cone structure, and the bottle opening is arranged on a first end of the bottle, and width of the first end of the bottle is less than width of a second end of the bottle, which makes the bottle stopper be conveniently inserted in the bottle opening. The circular truncated cone structure is a specific structure of the bottle.

Furthermore, the head cover is a cone structure, and an edge of the head cover is in contact with a lateral wall of the bottle when the bottle stopper is inserted in the bottle opening and the head cover is sleeved around the bottle stopper. The cone structure is a specific structure of the head cover, the edge of the head cover is in contact with the lateral wall of the bottle, and the head cover is matched with the bottle, which improve connecting tightness between the bottle and the head cover.

Furthermore, the bottle is configured with a platform, where the edge of the head cover is placed on the platform and the edge of the head cover is matched with the platform, which improves matching between the bottle and the head cover, and closely connecting of the bottle and the head cover.

Furthermore, the bottle stopper comprises a first plug mouth inserted in the bottle opening, and a second plug mouth. The first plug mouth is arranged at a first end of the bottle stopper, and the second plug mouth is arranged at a second end of the bottle stopper. The head cover comprises an inserted groove, and the second plug month is inserted in the inserted groove, which makes the bottle stopper be fixed in the head cover, thus, firm combination is formed among the head cover, the bottle stopper, and the bottle, thereby improving protection of the head cover for the bottle stopper.

Furthermore, the bottle opening is a circular structure, the first plug mouth is correspondingly a cylindrical structure. This is specific structures of the bottle and the first plug mouth, which improves closely matching of the bottle and the bottle stopper, further avoiding leakage of liquid.

Furthermore, the inserted groove is a circular groove, and the second plug mouth is a cylindrical structure. This is specific structures of the inserted groove and the second plug mouth, which makes closely matching of the bottle stopper and the head cover.

Furthermore, the first plug mouth and the second plug mouth both are configured with rounded corner, which makes the first plug mouth be conveniently inserted in the bottle opening, and makes the second plug mouth be conveniently inserted in the inserted groove.

Furthermore, the decorative lamp further comprises a limited piece sleeved on the first plug mouth, and the limited piece is bonded with an inner wall of the head cover through adhesive. The second plug mouth is inserted in the inserted groove of the head cover, and the bottle stopper is fixed and matched with the head cover, the limited piece is sleeved on the first plug mouth and is bonded with the inner wall of the head cover through the adhesive. Thus, the limited piece limits the bottle stopper, and avoids fall-out of the bottle stopper from the head cover. The bottle is matched with the bottle stopper and the head cover after the bottle stopper is firmly matched with the head cover, when the head cover is pressed, the first plug mouth of the bottle stopper is inserted in the bottle opening, and the edge of the head cover is matched with the lateral wall of the bottle. When the head cover is taken off, the bottle stopper is taken off together, thus, damage of the bottle stopper is avoided.

The decorative lamp of the present disclosure comprises the housing, the circuit board arranged in the housing, the bottle arranged at the top part of the housing and containing liquid, the bottle stopper sealing the bottle opening of the bottle, and the head cover sleeved around the bottle stopper, where the lamp is arranged on the circuit board, which avoids damage of the bottle stopper and makes the bottle stopper be closely matched with the bottle opening, thereby avoiding leakage of liquid due to looseness of the bottle stopper.

### BRIEF DESCRIPTION OF FIGURES

FIG. 1 is an assembled structural diagram of a decorative lamp of an example of the present disclosure.

FIG. 2 is an exploded structural diagram of the decorative lamp of the example of the present disclosure.

FIG. 3 is a cross-sectional structural diagram of the decorative lamp of the example of the present disclosure.

FIG. 4 is a structural diagram of a bottle of the example of the present disclosure.

FIG. 5 is a structural diagram of a bottle stopper of the example of the present disclosure.

FIG. 6 is a structural diagram of a head cover of the example of the present disclosure.

### LEGENDS

1. housing, 2. circuit board; 21. lamp; 3. bottle; 31. bottle opening; 32. platform; 4. bottle stopper; 41. first plug mouth; 42. second plug mouth; 43. plug body; 5. cover; 51. inserted groove; 6. base; 7. sealing cover; 100. decorative lamp.

### DETAILED DESCRIPTION

The present disclosure will further be described in detail in accordance with the figures and the exemplary examples.

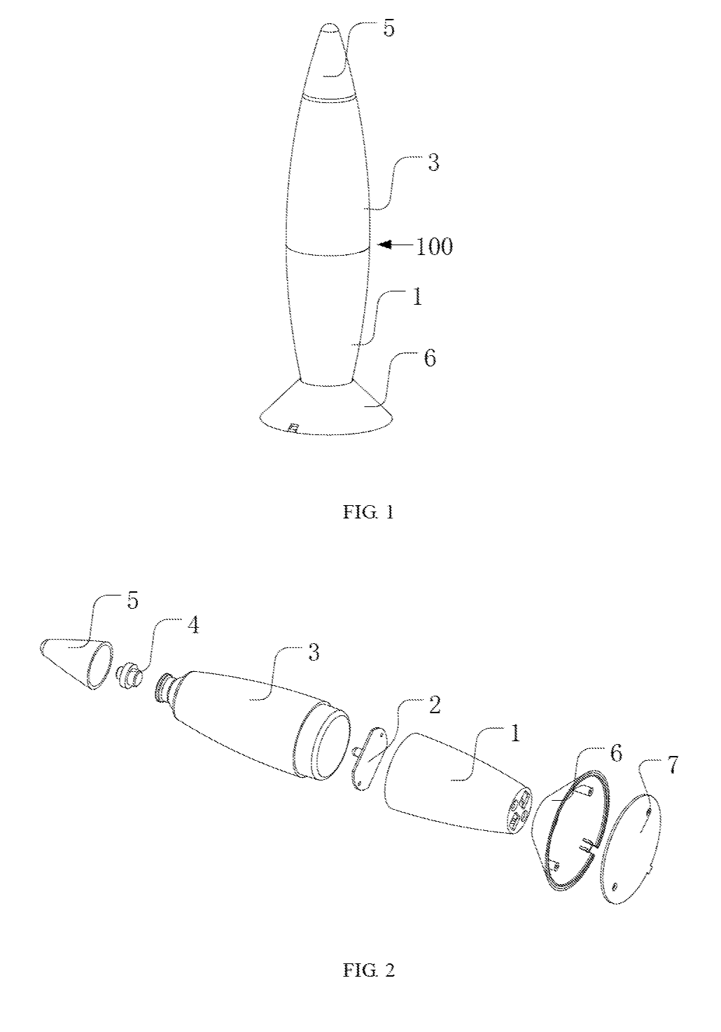

As shown in FIG. 1-FIG. 6, a decorative lamp 100 of the present disclosure comprises a housing 1, a circuit board 2 arranged in the housing 1, a bottle 3 arranged at a top part of the housing 1 and containing liquid, a bottle stopper 4 sealing a bottle opening 31 of the bottle 3, and a head cover 5 sleeving around the bottle stopper 4, where a lamp 21 is arranged on the circuit board. The decorative lamp 100 avoids damage of the bottle stopper 4 and closely matches the bottle stopper 4 with the bottle opening 31, thereby avoiding leakage of liquid due to looseness of the bottle stopper.

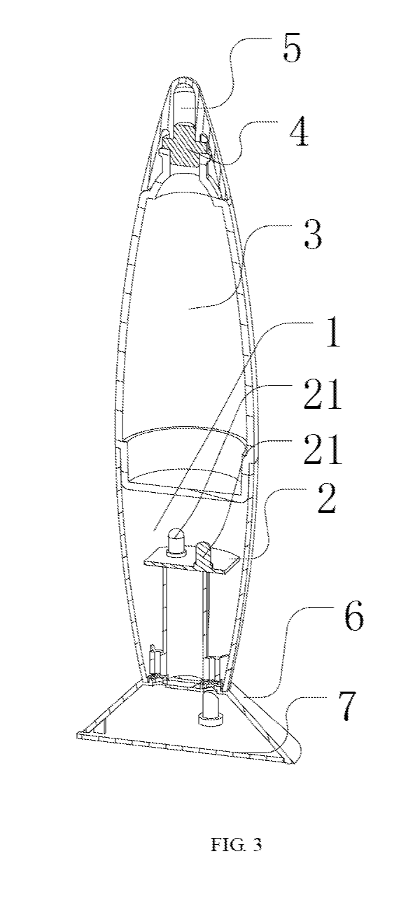

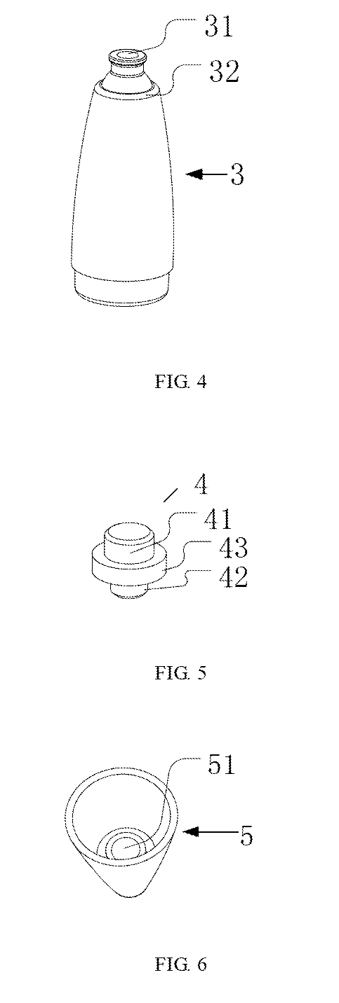

As shown in FIG. 1 and FIG. 3, the head cover 5 sleeves around the bottle stopper 4 and matches with the bottle 3. When the bottle stopper 4 is inserted into the bottle opening 31 and the head cover 5 sleeves around the bottle stopper 4, an edge of the head cover 5 is matched with and in contact with a lateral wall of the bottle 3, thus, damage of the bottle stopper 4 is avoided, thereby avoiding leakage of liquid due to looseness of the bottle stopper. As shown in FIG. 4, the bottle opening 31 is arranged at a top part of the bottle 3. The bottle is a circular truncated cone structure, and the bottle opening 31 is arranged on a first end of the bottle, and width of the first end of the bottle is less than width of a second end of the bottle. As shown in FIG. 6, the head cover 5 is a cone structure, and width of a first end of the head cover 5 is greater than width of a second end of the head cover 5, and the first end of the head cover 5 fits to an edge of a top part of the bottle 3. It should be understood that the bottle 3 and the head cover 5 may be other structures. The bottle is configured with a platform 32, where the edge of the head cover 5 is placed on the platform 32, and the edge of the head cover 5 is fit to the platform thereby improving matching between the bottle to the head cover 5, and connection between the bottle and the head cover 5. A thickness of the edge of the head cover 5 is equal to a width of the platform 32, which makes an outer surface at the joint between the bottle 3 and the head cover 5 be flat, thereby beautifying the decorative lamp 100.

As shown in FIG. 3, a first end of the bottle stopper 4 is connected to the bottle 3, and a second end of the bottle stopper 4 is connected to the head cover 5. As shown in FIG. 5, the bottle stopper 4 comprises a first plug mouth 41 inserted in the bottle opening 31, a second plug mouth 42, and a plug body arranged between the first plug mouth 41 and the second plug mouth 42, where the first plug mouth 41 is arranged at the first end of the bottle stopper 4 and the second plug mouth 42 is arranged at the second end of the bottle stopper. The first plug mouth 41 is matched with the bottle opening 31 and is closely connected to the bottle opening 31, which avoids leakage of liquid. The bottle opening 31 is circular and the first plug mouth 41 is cylindrical. As shown in FIG. 6, the head cover 5 is configured with an inserted groove 51, and the second plug mouth 42 is inserted in the inserted groove 51, which makes the bottle stopper 4 be fixed in the head cover 5, thus, firm combination is formed among the head cover 5, the bottle stopper 4, and the bottle 3, thereby improving protection of the head cover 5 for the bottle stopper 4. The inserted groove 51 is a circular groove, and the second plug mouth 42 is a cylindrical structure and is matched with the inserted groove 51, which makes the bottle stopper 4 closely match with the head cover 5. It should be understood that the inserted groove 51 and the second plug mouth 42 may be other structures. The plug body 43 of the bottle stopper 4 is also a cylindrical structure, and a diameter of the plug body 43 is greater than a diameter of the first plug mouth 41 and a diameter of the second plug mouth 42, which has limiting effect.

In the example, the bottle stopper 4 is made of rubber, and the rubber is changeable, which makes the bottle stopper 4 be easily inserted in and match with the head cover. As shown in FIG. 5, top parts of the first plug mouth 41 and the second plug mouth 42 are both configured with rounded corner, which is convenient for matching among the head cover 5, the bottle stopper 4, and the bottle 3.

The decorative lamp 100 further comprises a limited piece (not shown in Figures) sleeved on the first plug mouth 41, where the limited piece is bonded with an inner wall of the head cover 5 through adhesive. In the specific description, the second plug mouth 42 is inserted in the inserted groove 51 of the head cover 5, and the bottle stopper 4 is fixed and matched with the head cover 5, the limited piece is sleeved on the first plug mouth 41 and is bonded with the inner wall of the head cover 5 through the adhesive. Thus, the limited piece limits the bottle stopper 4, and avoids fall-out of the bottle stopper from the head cover 5. The bottle 3 is matched with the bottle stopper 4 and the head cover 5 after the bottle stopper 4 is firmly matched with the head cover 5. When the head cover 5 is pressed, the first plug, mouth 41 of the bottle stopper 4 is inserted in the bottle opening 31, and the edge of the head cover 5 is matched with the lateral wall of the bottle 3. When the head cover 5 is taken off, the bottle stopper 4 is taken off together, thus, damage of the bottle stopper 4 is avoided. The limited piece is a circle annular structure, where an inner diameter of the limited piece greater than or is equal to the diameter of the first plug mouth 41, and is less than a diameter of the bottle stopper 43 and an outer diameter of the edge of the bottle opening 3, thus, the limited piece is limited between the bottle opening 31 and the plug body 43.

As shown in FIG. 2, the decorative lamp further comprises a base 6 and a sealing, cover 7 fixed to the base 6, which makes the decorative lamp be easily placed.

The present disclosure is described in detail in accordance with the above contents with the specific exemplary examples. However, this present disclosure is not limited to the specific examples. For the ordinary technical personnel of the technical field of the present disclosure, on the premise of keeping the conception of, the technical personnel can also make simple deductions or replacements, and all of which should be considered to belong to the protection scope of the present disclosure.

We claim:

1. A decorative lamp, comprising:
a housing;
a circuit board arranged in the housing;
a bottle arranged at a top part of the housing;
a bottle stopper sealing a bottle opening of the bottle; and
a head cover sleeved around the bottle stopper;
wherein the bottle contains liquid, and a lamp is arranged on the circuit board.

2. The decorative lamp of claim 1, wherein the head cover is sleeved around the bottle stopper and is matched with the bottle.

3. The decorative lamp of claim 2, wherein the bottle is a circular truncated cone structure, and the bottle opening is arranged at a first end of the bottle, and width of the first end of the bottle is less than width of a second end of the bottle.

4. The decorative lamp of claim 3, wherein the head cover is a cone structure, and an edge of the head cover is in contact with a lateral wall of the bottle when the bottle stopper is inserted in the bottle opening and the head cover is sleeved around the bottle stopper.

5. The decorative lamp of claim 4, wherein the bottle is configured with a platform, and the edge of the head cover is placed on the platform.

6. The decorative lamp of claim 1, wherein the bottle stopper comprises a first plug mouth inserted in the bottle opening, and a second plug mouth; the first plug mouth is arranged at a first end of the bottle stopper, and the second plug mouth is arranged at a second end of the bottle stopper; the head cover is configured with an inserted groove, and the second plug mouth is inserted in the inserted groove.

7. The decorative lamp of claim 6, wherein the bottle opening is a circular structure, and the first plug mouth is correspondingly a cylindrical structure.

8. The decorative lamp of claim 6, wherein the inserted groove is a circular groove, and the second plug mouth is a cylindrical structure.

9. The decorative lamp of claim 6, wherein the first plug mouth and the second plug mouth are both configured with rounded corner.

10. The decorative lamp of claim 6, further comprising a limited piece sleeved on the first plug mouth, and the limited piece is bonded with an inner wall of the head cover through adhesive.
